(19) United States
(12) Patent Application Publication
(10) Pub. No.: US 2007/0274899 A1
(43) Pub. Date: Nov. 29, 2007

(54) TEMPERATURE-STABLE CATALYSTS FOR GAS PHASE OXIDATION, AND PROCESSES FOR USING THE SAME

(75) Inventors: Aurel Wolf, Wulfrath (DE); Leslaw Mleczko, Dormagen (DE); Oliver Felix-Karl Schluter, Leverkusen (DE); Stephan Schubert, Leverkusen (DE); Jurgen Kintrup, Leverkusen (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,517

(22) Filed: May 23, 2007

(30) Foreign Application Priority Data
May 23, 2006 (DE) 102006024550.4

(51) Int. Cl. C01B 7/04; B01J 21/18; C01B 7/00

(52) U.S. Cl. 423/502; 502/185; 502/180; 502/182; 502/184

(57) ABSTRACT

Oxidation catalysts which comprise at least one constituent active in the catalysis of oxidation reactions, and a support for said constituent, characterized in that the support includes carbon nanotubes; are disclosed along with processes for their use including the oxidation of hydrogen chloride. Such catalysts can exhibit a higher stability and activity than that of catalysts of the state of the art.

### BACKGROUND OF THE INVENTION

It is generally known that certain metals, for example, ruthenium, can be used as a reduction catalyst or as an oxidation catalyst (see, e.g., Handbook of Heterogeneous Catalysis).

A typical example of the use of ruthenium in an oxidation reaction is the reaction of hydrogen chloride with oxygen. Because of the high temperatures that are used in such reactions (approx. 350° C.), ruthenium is usually applied to oxidic support materials.

The application of ruthenium to carbon-containing supports, e.g., activated carbon or carbon black, may be mentioned as another possible method of producing catalysts. Because of the sensitivity of the carbon support to oxidation, especially at high temperatures, such Ru catalysts are used principally in liquid phases or electrochemical applications. Such Ru/C catalysts can be used as oxidation catalysts for the oxidation of methanol in a fuel cell with a carbon-supported platinum/ruthenium catalyst. An Ru/C catalyst is also used in the oxidation of carbon monoxide (Mater. Res. Soc. Symp. Proceedings 756 (2003) 397-402) and together with titanium in the oxidation of ethanol (J. Appl. Electrochem. 30 (4) (2000) 467-474).

Multi-wall carbon nanotubes are increasingly being used as supports for catalytically active metals in certain electrochemical processes where the carbon nanotubes partially or completely replace the conductive carbon black conventionally used, for example, as electrode materials on the basis of their high electrical conductivity. Such electrodes are frequently used in fuel cells for the oxidation of methanol and ethanol (Carbon 42 (15) (2004) 3257-3260). These reactions are carried out at low temperatures below 150° C.

It is further known from the literature that, on the basis of their stability towards oxidative attack at high temperatures, multi-wall carbon nanotubes can be used as a catalyst, without any other catalytic component, for certain high-temperature reactions. For example, they are used as an oxidation catalyst in the oxidative dehydrogenation of ethylbenzene to styrene (Catal. Today 102-103 (2005) 110-114).

Carbon nanotubes are also used in the electrochemical oxidation of catecholamines and catechols (Analyst 131 (2) (2006) 262-267) and glutathione (Electrochemica Acta 51 (15) (2006) 3046-3051) and in combination with platinum in the electrochemical oxidation of cysteine (Analytica Chimica Acta 557 (1-2) (2006) 52-56). The use of multi-wall carbon nanotubes in combination with ruthenium as the catalytically active component is not known.

A known process for the oxidation of hydrogen chloride to chlorine under more drastic conditions with respect to temperature and oxygen partial pressure is the process developed by Deacon in 1868 for the catalytic oxidation of hydrogen chloride with oxygen:
4HCl+O₂→2Cl₂₊₂H₂O

The oxidation of hydrogen chloride to chlorine is an equilibrium reaction. With increasing temperature the position of the equilibrium shifts to the disadvantage of the desired end product. It is therefore advantageous to use catalysts with the highest possible activity which allow the reaction to proceed at low temperature. The first catalysts for the oxidation of hydrogen chloride with ruthenium as the catalytically active component, known as early as 1965, were based on RuCl₃. Other Ru-based catalysts with ruthenium oxide or ruthenium mixed oxide as the active substance are known, where the content of ruthenium oxide is 0.1 wt. % to 20 wt. % and the mean particle diameter of ruthenium oxide is 1.0 nm to 10.0 nm. Other Ru catalysts supported on titanium oxide or zirconium oxide are known. For the preparation of the ruthenium chloride catalysts which contain at least one of the compounds titanium dioxide and zirconium dioxide, a number of Ru starting compounds such as ruthenium-carbonyl complexes, ruthenium salts of inorganic acids, ruthenium-nitrosyl complexes, ruthenium-amine complexes, ruthenium complexes of organic amines or ruthenium-acetylacetonate complexes are known. Although Ru catalysts possess a very high activity, they tend to sinter and hence lose their activity at higher temperatures. However, an improvement in the economy of such catalysts requires a further increase in activity, coupled with good long-term stability.

Known supported ruthenium oxidation catalysts have an insufficient activity/stability. For example, for the oxidation of hydrogen chloride, known catalysts exhibit an insufficient activity. Although the activity can be increased by raising the reaction temperature, this leads to sintering/deactivation or a loss of catalytic component.

### BRIEF SUMMARY OF THE INVENTION

One object of the present invention includes providing a catalyst for effecting oxidation reactions, e.g., the oxidation of hydrogen chloride, at low temperatures and with high activities.

Surprisingly, it has been found that by supporting metals and/or metal compounds which are catalytically active in oxidation, e.g., ruthenium, on carbon nanotubes (CNT), highly active catalysts can be prepared which have a markedly higher catalytic activity than the catalysts known from the state of the art. It has also been found, surprisingly, that the catalysts according to the invention based on carbon nanotube support materials have excellent stability in an oxygen-containing atmosphere, even at high temperatures.

The present invention relates to catalysts for oxidation reactions which catalysts comprise at least one constituent active in the catalysis of oxidation reactions, and a support for said constituent, characterized in that the support includes carbon nanotubes. Such catalysts can be distinguished by a higher stability and activity than that of catalysts of the state of the art.

One embodiment of the present invention includes an oxidation catalyst comprising a catalytically-active component on a support material comprising carbon nanotubes.

Another embodiment of the present invention includes a process comprising: (a) providing a substance to be oxidized; and (b) subjecting the substance to oxidation in the presence of an oxidation catalyst comprising a catalytically-active component on a support material comprising carbon nanotubes.

Yet another embodiment of the present invention includes a process comprising: (a) providing a gas stream comprising hydrogen chloride; and (b) oxidizing the hydrogen chloride with oxygen at a temperature of 50° C. to 350° C., in the presence of an oxidation catalyst comprising a ruthenium compound on a support material comprising carbon nanotubes, wherein the ruthenium compound is selected from the group consisting of halides, oxides, hydroxides, oxyhalides, or mixtures thereof.

### BRIEF DESCRIPTION OF THE SEVERAL VIEWS OF THE DRAWING

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a graph depicting the long term stability of a catalyst according to one embodiment of the present invention;

FIG. 2 is a graph depicting the long term stability of a catalyst according to one embodiment of the present invention at variable temperature; and

FIG. 3 is a transmission electron micrograph of a catalyst according to one embodiment of the present invention.

### DETAILED DESCRIPTION OF THE INVENTION

As used herein, the singular terms “a” and “the” are synonymous and used interchangeably with “one or more.” Accordingly, for example, reference to “a gas” herein or in the appended claims can refer to a single gas or more than one gas. Additionally, all numerical values, unless otherwise specifically noted, are understood to be modified by the word “about.”

An oxidation reaction is understood as meaning a reaction in which at least one element participating in the reaction is oxidized, i.e., changes to a higher oxidation state.

Carbon nanotubes are principally understood as meaning cylindrical carbon tubes whose diameter is preferably between 3 and 150 nm and whose length is a multiple of the diameter, preferably at least 100 times the diameter. Such carbon nanotubes comprise layers of ordered carbon atoms and have a morphologically different core. These carbon nanotubes are also called carbon fibrils or hollow carbon fibres, for example. By virtue of their dimensions and their particular properties, the carbon nanotubes described are of industrial importance, e.g., in the production of composite materials.

Carbon nanotubes, especially those with a diameter of 3-150 nm and a length:diameter aspect ratio (L:D) of >100, can preferably be produced by decomposing hydrocarbons on a heterogeneous catalyst containing Mn, Co and preferably also molybdenum, together with an inert support.

Carbon nanotubes are distinguished by a high thermal conductivity (>2000 W/m.K) and a fullerene-like structure. The former allows a high dissipation of the heat of reaction, and the latter allows a particular stabilization of high oxidation states. A further advantage of carbon nanotubes over other carbon forms is the much higher oxidation stability compared with amorphous carbon. The carbon nanotubes used can be single-wall or multi-wall, the latter being preferred and a number of walls of 3-50 being particularly preferred. The diameter is 1-500 nm, preferably 2-50 nm and particularly preferably 2-30 nm. The length of the carbon nanotubes can be 10 nm-10 mm, preferably 100 nm-1 mm and particularly preferably 1-100 μm. The BET specific surface area of the carbon nanotubes can preferably be 20-1000 m²/g and particularly preferably 100-400 m²/g. The carbon nanotubes in question can generally be used as-produced or else prepurified. In one preferred embodiment, surface-modified carbon nanotubes are used. A surface modification is understood as meaning the oxidative treatments of carbon nanotubes with oxidizing compounds such as acids like HNO₃, H₂SO₄, HClO₄ and mixtures thereof, or other oxidizing media such as H₂O₂, O₂, O₃, CO₂, etc., with which those skilled in the art are generally familiar. However, other modifications, e.g., functionalization with amine groups, are also known.

Such suitable carbon nanotubes are described, e.g., in WO2006/050903, the entire contents of which are incorporated herein by reference. Suitable carbon nanotubes are available commercially, for example, Baytubes® carbon nanotubes from Bayer Material Science AG (Leverkusen, Germany).

Any constituents that catalyse an oxidation reaction are suitable as main catalytically active components. For example, the following elements or compounds thereof are suitable: ruthenium, osmium, rhodium, iridium, palladium, platinum, copper, silver, gold, rhenium, bismuth, cobalt, iron or mixtures thereof. In one preferred embodiment, ruthenium and/or its compounds are used. In one very particularly preferred embodiment, without implying a limitation, ruthenium is used in oxidic form, as a chloride compound or as an oxychloride compound.

In another embodiment of the process according to the invention, the catalytically active component can be applied to the support in a non-oxidic form and is converted to the oxidized form in the course of the reaction. Conventionally, the loading of the catalytically active component is in the range 0.1-80 wt. %, preferably in the range 1-50 wt. % and particularly preferably in the range 1-25 wt. %, based on the total weight of catalyst and support.

The catalytic component can be applied by various processes. For example, without implying a limitation, it is possible to use moist and wet impregnation of a support with suitable starting compounds present in solution or starting compounds in liquid or colloidal form, precipitation and coprecipitation processes, as well as ion exchange and vapour phase deposition (CVD, PVD). A preferred method is a combination of impregnation and subsequent precipitation with reducing substances (preferably hydrogen, hydrides or hydrazine compounds) or alkaline substances (preferably NaOH, KOH or ammonia).

Suitable promoters are metals with a basic action (e.g., alkali metals, alkaline earth metals and rare earth metals), alkali metals, especially Na and Cs, and alkaline earth metals being preferred and alkaline earth metals, especially Sr and Ba, being particularly preferred.

Without implying a limitation, the promoters can be applied to the catalyst by impregnation and CVD processes, preference being given to impregnation, particularly preferably after application of the main catalytic component.

Without implying a limitation, the dispersion of the main catalytic component can be stabilized e.g., by using various dispersion stabilizers such as scandium compounds, manganese oxides and lanthanum oxides. The stabilizers are preferably applied together with the main catalytic component by impregnation and/or precipitation.

The catalysts can be dried under normal pressure or, preferably, under reduced pressure under a nitrogen-argon or an air atmosphere, at 40 to 200° C. The drying time is preferably 10 min to 6 h.

The catalysts can be used in uncalcined or calcined form. Calcination can take place in a reducing, oxidizing or inert phase, calcination in a stream of air or nitrogen being preferred. When oxygen is excluded, calcination can be carried out at a temperature of 150 to 600° C., preferably 200 to 300° C. In the presence of oxidizing gases, calcination can be carried out at a temperature of 150 to 400° C., preferably 200 to 300° C.

Preferably, catalysts in accordance with the present invention are used, as already described above, in catalytic processes known as the Deacon process. In such processes, hydrogen chloride is oxidized with oxygen in an exothermic equilibrium reaction to form chlorine, with the formation of steam. The reaction temperature is usually 150 to 450° C., and the normal reaction pressure is 1 to 25 bar. Since the reaction is an equilibrium reaction, it is appropriate to use the lowest possible temperatures at which the catalyst still has sufficient activity. It is also appropriate for oxygen to be used in superstoichiometric quantities in relation to the hydrogen chloride. A two- to four-fold oxygen excess is for example commonly used. Since no selectivity losses need to be feared, it can be economically advantageous to carry out the reaction at a relatively high pressure and an accordingly longer residence time than when using normal pressure.

In addition to a ruthenium compound, suitable catalysts can also be compounds of other noble metals, such as for example gold, palladium, platinum, osmium, iridium, silver, copper or rhenium. Suitable catalysts can also contain chromium(III) oxide.

The catalytic hydrogen chloride oxidation can be carried out adiabatically or preferably isothermally or approximately isothermally, or discontinuously, but preferably continuously in the form of a fluidized or fixed bed process, and preferably in the form of a fixed bed process, and particularly preferably in tube bundle reactors on heterogeneous catalysts at a reactor temperature of 180 to 450° C., preferably 200 to 400° C., particularly preferably 220 to 350° C. and a pressure of 1 to 25 bar (1000 to 25000 hPa), preferably 1.2 to 20 bar, particularly preferably 1.5 to 17 bar and in particular 2.0 to 15 bar.

Conventional reaction apparatuses in which the catalytic hydrogen chloride oxidation is carried out are fixed bed or fluidized bed reactors. Catalytic hydrogen chloride oxidation can preferably also be carried out in several stages.

For the adiabatic, isothermal or approximately isothermal mode of operation it is also possible to use more than one, i.e. 2 to 10, preferably 2 to 6, particularly preferably 2 to 5, and in particular 2 to 3 series-connected reactors with intermediate cooling. The oxygen can be added either completely together with the hydrogen chloride upstream of the first reactor or in a distributed manner over the various reactors. This series connection of individual reactors can also be combined in one apparatus.

An additional preferred variant of a device suitable for the process consists in using a structured catalyst bed in which the catalyst activity increases in the direction of flow. Such structuring of the catalyst bed can be obtained by varying the impregnation of the catalyst support with the active composition or varying the dilution of the catalyst with an inert material. The inert material used can for example be rings, cylinders or beads of titanium dioxide, zirconium dioxide or mixtures thereof, aluminium oxide, steatite, ceramics, glass, graphite or stainless steel. In the case of the preferred use of shaped catalysts, the inert material should preferably have similar external dimensions.

Suitable shaped catalysts starting from carbon nanotubes have any desired shapes. Preferably the catalysts are shaped in the form of tablets, rings, cylinders, stars, wheels or beads. Particularly preferred shapes are rings, cylinders or star-shaped strands.

Suitable support materials which can be combined with carbon nanotubes are for example silicon dioxide, graphite, titanium dioxide with a rutile or anatase structure, zirconium dioxide, aluminium oxide or mixtures thereof and preferably titanium dioxide, zirconium dioxide, aluminium oxide or mixtures thereof and particularly preferably γ- or δ-aluminium oxide or mixtures thereof.

The shape forming of the catalyst can be effected after or preferably before the impregnation of the catalyst support.

The conversion rate of hydrogen chloride in a single passage can preferably be limited to 15 to 90%, preferably 40 to 85%, and particularly preferably 50 bis 70%. Any non-converted hydrogen chloride can be separated off and partially or completely recycled to the catalytic hydrogen chloride oxidation process. The volumetric ratio of hydrogen chloride to oxygen at the inlet of the reactor is preferably between 1:1 and 20:1, preferably between 2:1 and 8:1, and particularly preferably between 2:1 and 5:1.

The heat of reaction of the catalytic hydrogen chloride oxidation can advantageously be used for the production of high-pressure steam. This can be used for operating a phosgenation reactor or distillation columns, and in particular isocyanate distillation columns.

The catalyst according to the invention for the oxidation of hydrogen chloride is distinguished by a high activity at low temperatures. Without being bound to one theory, it may be assumed that the CNT are effective as a stabilizer of high oxidation states (e.g., Ru(VIII)).

The following examples are for reference and do not limit the invention described herein.

### EXAMPLES

### Example 1

### Modification of Carbon Nanotubes

In a multinecked flask with heating plate and reflux condenser, 20.0 g of multi-wall carbon nanotubes (Baytubes® carbon nanotubes from Bayer Material Science AG (Leverkusen, Germany)) were boiled for 5 h in concentrated nitric acid, with stirring. The carbon nanotubes modified in this way were then dried under vacuum at 40° C. for 8 h. The product was examined by photoelectron spectroscopy (XPS), transmission electron spectroscopy and acid-base titration. The modified CNT contain approx. 1 mmol of acid groups per gram.

### Example 2

### Catayltically Active Component Supported on Carbon Nanotubes

(Preparation of a Catalyst According to the Invention)

In a round-bottomed flask with dropping funnel and reflux condenser, 18 g of CNT from Example 1 were suspended in a solution of 2.35 g of commercially available ruthenium chloride n-hydrate in 50 ml of water and the suspension was stirred for 30 min. 24 g of 10% sodium hydroxide solution were then added dropwise over 30 min and the mixture was stirred for 30 min. A further 12 g of 10% sodium hydroxide solution were then added dropwise over 15 min and the reaction mixture was heated to 65° C. and maintained at this temperature for 1 h. After cooling, the suspension was filtered and the solid was washed 5 times with 50 ml of water. The moist solid was dried at 120° C. in a vacuum drying cabinet for 4 h and then calcined at 300° C. in a stream of air to give a ruthenium oxide catalyst supported on CNT. The calculated amount of ruthenium was Ru/(RuO₂+CNT)=10%.

The product was examined by X-ray photoelectron spectroscopy (XPS). The result showed that the ruthenium phase consists of 72% of RuO₂, 20% of RuO₃ and 8% of RO₄.

For use in the catalyst test, the catalyst was diluted with quartz particles to a concentration of 17 wt. %, based on the total amount.

### Example 3

### Catalytically Active Component Supported on Titanium Dioxide

(Comparative Catalyst not According to the Invention)

A ruthenium-on-titanium dioxide catalyst (4.7 or 10% Ru w/w) was prepared according to the process in Example 2 and calcined at 300° C. in a stream of air (3a or 3b).

Catalytic Tests

### Example 4

### Use of the Catalysts of Examples 2 and 3 in the Oxidation of HCl

A gaseous mixture of 80 ml/min (STP) of hydrogen chloride and 80 ml/min (STP) of oxygen was passed through a fixed bed of the catalysts of Examples 2 and 3 in a quartz reaction time (diameter 10 mm) at 300° C. The quartz reaction tube was heated by means of an electrically heated fluidized bed of sand. After 30 min the stream of product gas was passed into 16% potassium iodide solution for 10 min. The iodine formed was then back-titrated with 0.1 N standard thiosulfate solution in order to establish the amount of chlorine introduced. The amounts of chlorine found are listed in Table 1. Photoelectron spectroscopy gave the proportions of Ru(IV), Ru(VI) and Ru(VIII) oxide listed in . . . for the catalysts of Examples 2, 3 and 6.

### Example 5

### Blank Experiment with CNT

As a blank experiment the catalyst was replaced with CNT from Example 1 and the test was performed as described in Example 4. The activity listed in Table 1 was found. The small amount of chlorine produced is attributable to the gas phase reaction.

TABLE 1
Activity in the oxidation of HCl

| | | | Chlorine | Chlorine |
|---|---|---|---|---|
| | | M | formation | formation |
| Ex- | | (cat) | mmol/ | mmol/ |
| ample | Composition | g | min · g (cat) | min · g (Ru) |
| 2 | RuO₂/CNTₒₓ (10% Ru) | 0.191 | 1.029 | 10.29 |
| 3 | RuO₂/TiO₂ (10% Ru) | 0.612 | 0.820 | 8.20 |
| 5 | CNTₒₓ | (0.483) | (0.084) | — |

### Example 6

### Long-Term Stability of a CNT-Supported Catalyst

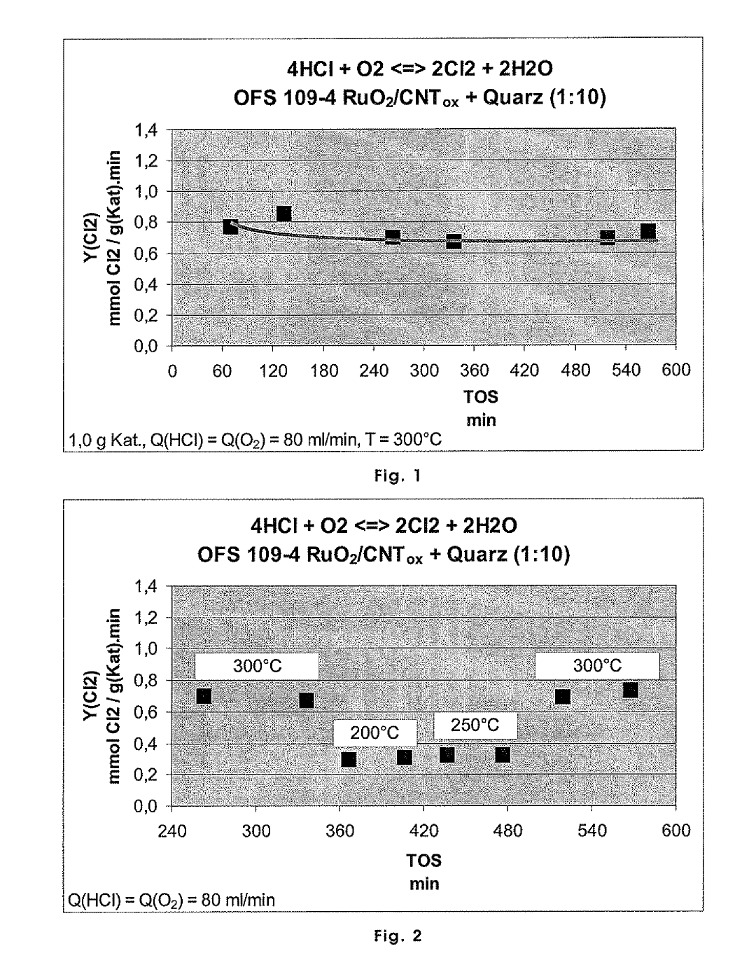

The ruthenium-on-CNT catalyst from Example 2 was tested as described in Example 4, but the experimental time was increased and several samples were taken by passing the product gas into 16% potassium iodide solution for 10 minutes. The amounts of chlorine listed in FIG. 1 are found.

### Example 7

### CNT-Supported Catalyst Activity Temperature Dependence

The ruthenium-on-CNT catalyst from Example 2 was tested as described in Example 4, but the temperature was varied in the range 200 to 300° C. Two control measurements at the end prove that no deactivation phenomena occurred during the temperature variation. The amounts of chlorine listed in FIG. 2 are found.

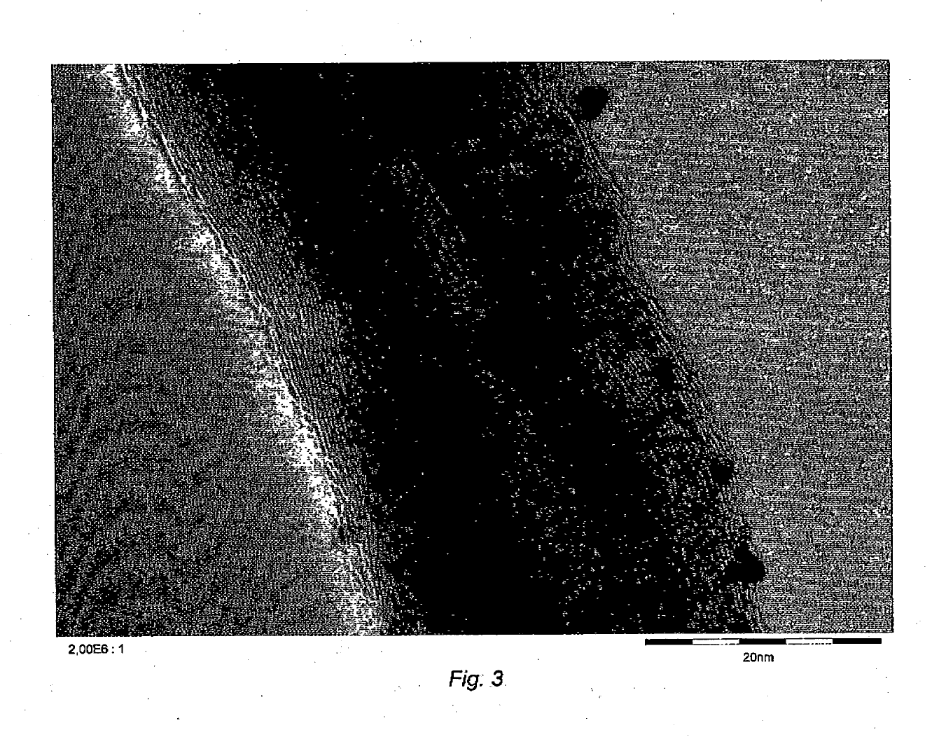

FIG. 3 shows a transmission electron micrograph of a catalyst according to the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An oxidation catalyst comprising a catalytically-active component on a support material comprising carbon nanotubes.

2. The oxidation catalyst according to claim 1, wherein the catalytically-active component comprises a substance having at least one element selected from the group consisting of ruthenium, osmium, rhodium, iridium, palladium, platinum, copper, silver, gold, rhenium, bismuth, cobalt, vanadium, chromium, manganese, nickel, tungsten, iron and combinations thereof.

3. The oxidation catalyst according to claim 1, wherein the catalytically-active component comprises ruthenium.

4. The oxidation catalyst according to claim 1, prepared by a process comprising applying an aqueous form of the catalytically-active component to the support material.

5. The oxidation catalyst according to claim 2, prepared by a process comprising applying an aqueous form of the catalytically-active component to the support material.

6. The oxidation catalyst according to claim 3, prepared by a process comprising applying an aqueous form of the catalytically-active component to the support material.

7. The oxidation catalyst according to claim 3, wherein the catalytically-active component is applied to the support material in an aqueous form and the catalytically-active component comprises a ruthenium compound selected from the group consisting of halides, oxides, hydroxides, oxyhalides, or mixtures thereof.

8. A process comprising:
(a) providing a substance to be oxidized;
(b) subjecting the substance to oxidation in the presence of an oxidation catalyst according to claim 1.

9. A process comprising:
(a) providing a substance to be oxidized;
(b) subjecting the substance to oxidation in the presence of an oxidation catalyst according to claim 2.

10. A process comprising:
(a) providing a substance to be oxidized;
(b) subjecting the substance to oxidation in the presence of an oxidation catalyst according to claim 3.

11. The process according to claim 8, wherein the oxidation is carried out at a temperature above 50° C.

12. The process according to claim 8, wherein the oxidation is carried out at a temperature of 50° C. to 350° C.

13. The process according to claim 8, wherein the substance to be oxidized comprises hydrogen chloride.

14. The process according to claim 9, wherein the oxidation is carried out at a temperature above 50° C.

15. The process according to claim 9, wherein the oxidation is carried out at a temperature of 50° C. to 350° C.

16. The process according to claim 9, wherein the substance to be oxidized comprises hydrogen chloride.

17. The process according to claim 10, wherein the oxidation is carried out at a temperature above 50° C.

18. The process according to claim 10, wherein the oxidation is carried out at a temperature of 50° C. to 350° C.

19. The process according to claim 10, wherein the substance to be oxidized comprises hydrogen chloride.

20. A process comprising:
(a) providing a gas stream comprising hydrogen chloride;
(b) oxidizing the hydrogen chloride with oxygen at a temperature of 50° C. to 350° C., in the presence of an oxidation catalyst comprising a ruthenium compound on a support material comprising carbon nanotubes, wherein the ruthenium compound is selected from the group consisting of halides, oxides, hydroxides, oxyhalides, or mixtures thereof.
